(19) United States
(12) Patent Application Publication
(10) Pub. No.: US 2004/0100903 A1
(43) Pub. Date: May 27, 2004

(54) Quality of service mechanisms for mobility access device

(76) Inventors: Seung-Jae Han, Basking Ridge, NJ (US); Scott C. Miller, Freehold, NJ (US)

Correspondence Address: DUANE MORRIS, LLP, IP DEPARTMENT, ONE LIBERTY PLACE, PHILADELPHIA, PA, 19103-7396, US

(21) Appl. No.: 10/448,181

(22) Filed: May 29, 2003

Related U.S. Application Data
(60) Provisional application No. 60/428,822, filed on Nov. 25, 2002.

(51) Int. Cl. H04L 12/28

(52) U.S. Cl. 370/230

(57) ABSTRACT

A gateway for handling flow of data to or from a plurality of mobile nodes includes an authentication, authorization and accounting (AAA) interface and a queue manager. The AAA interface receives information defining respective quality of service (QoS) levels for a plurality of mobile nodes. The QoS levels are selected from a group of at least two QoS levels. The queue manager individually throttles respective data flows to or from each mobile node while maintaining each data flow greater than or equal to its respective QoS level.

This application claims the benefit of U.S. Provisional Patent Application No. 60/428,822, filed Nov. 25, 2002.

### FIELD OF THE INVENTION

This invention is related to the field of wireless communication and more specifically to Quality of Service (QoS) mechanisms for mobility access devices.

### BACKGROUND

The lack of QoS support in the current IEEE 802.11 standard disallows any kind of QoS (e.g., network delay and/or throughput) provision in 802.11 networks. Current 802.11 networks cannot provide even basic fairness among users nor service level differentiation. For example, a significant unfairness among users can occur even among best-effort traffic—uplink users (e.g., users sending out emails) get higher throughput than their fair share at the expense of downlink users (e.g., users accessing the Worldwide Web (WWW) or reading email), when downlink users and uplink users coexist in 802.11 networks. This is highly undesirable, considering that the majority of wireless Internet applications are downlink-oriented.

Despite the effort of the 802.11 standard body, the availability of 802.11 air-link QoS in the near future is still uncertain. The difficulty of upgrading existing deployment to the new standard when it is available is another concern. Moreover, the 802.11 air-link QoS alone does not solve the end-to-end QoS problem.

A system and method are desired which solve this unfairness issue and also provide the service level differentiation (where the service level is defined by the throughput or the delay bound) without requiring 802.11 air-link QoS mechanisms or proprietary clients at the end user systems in a wireless access network that may include several 802.11 Access Points.

### SUMMARY OF THE INVENTION

A gateway for handling flow of data to or from a plurality of mobile nodes includes an authentication, authorization and accounting (AAA) interface and a queue manager. The AAA interface receives information defining respective quality of service (QoS) levels for a plurality of mobile nodes, wherein the QoS levels are selected from a group of at least two QoS levels. The queue manager individually throttles respective data flows to or from each mobile node while maintaining each data flow greater than or equal to its respective QoS level.

### BRIEF DESCRIPTION OF THE DRAWINGS

The following detailed description of preferred embodiments of the present invention will be better understood when read in conjunction with the appended drawing. For the purpose of illustrating the present invention, there are shown the drawing embodiment which is presently preferred. However, the present invention is not limited to the precise arrangements and instrumentality shown. In the drawing:

FIG. 1 illustrates the architecture for one embodiment of the present invention.

FIG. 2 is a block diagram of the exemplary QoS gateway of FIG. 1.

FIG. 3 is a flow chart showing a detail of operation of the queue management module of the QoS gateway.

FIG. 4 is a flow chart showing operation of the gateway of FIG. 2.

FIGS. 5 to 7 are diagrams showing experimental results for an exemplary quality of service management mechanism.

### DETAILED DESCRIPTION

U.S. Provisional Patent Application No. 60/428,822, filed Nov. 25, 2002, is incorporated by reference herein as though fully set forth in its entirety.

This description of the exemplary embodiments is intended to be read in connection with the accompanying drawings, which are to be considered part of the entire written description. In the description, relative positional terms should be construed to refer to the orientation as then described or as shown in the drawing under discussion. These relative terms are for convenience of description and do not require that the apparatus be constructed or operated in a particular orientation.

An exemplary method and gateway provides Quality of Service (QoS) in IEEE 802.11 networks without relying on air-link (802.11) QoS mechanisms. While virtually all of the existing QoS schemes for 802.11 networks (including the proposal by the IEEE 802.11e working group) operate at the Medium Access Control (MAC) layer, an exemplary method described herein operates at the Layer-3, the Internet Protocol (IP) layer. In other words, traffic can be controlled at the router which is located behind 802.11 cells.

One alternative is controlling the amount of traffic competing for air resources to avoid congestion when congestion occurs at an 802.11 cell, instead of prioritizing traffic. Because both upstream and downstream traffic are shaped in such a way that the total traffic volume never exceeds the capacity of the 802.11 air link, there will be no packet drop or delay caused by queuing or buffer overflow at the 802.11 air link. By tailoring traffic, different service classes can be provided at various granularity levels. For example, some embodiments are configured with three user classes (referred to herein as Gold, Silver, Bronze for convenience), where each class can be guaranteed a certain minimum bandwidth. Any desired number of QoS levels (e.g., seven or eleven) may be provided. Finer granularity of service classes is also possible, such as classification based on the combination of the user class and application class. Furthermore, some embodiments of the present invention can be configured to provide QoS control at the ISP link (i.e., backhaul link), which is another potential network bottleneck. Since the preferred embodiments work at the IP layer, the QoS mechanism described below can co-exist with future (level 2) QoS mechanisms that the IEEE 802.11e standard may mandate. The present invention is not 802.11-specific and is applicable to any kind of multi-access style wireless technologies such as Hyper-LAN, Home-RF, and Blue-tooth.

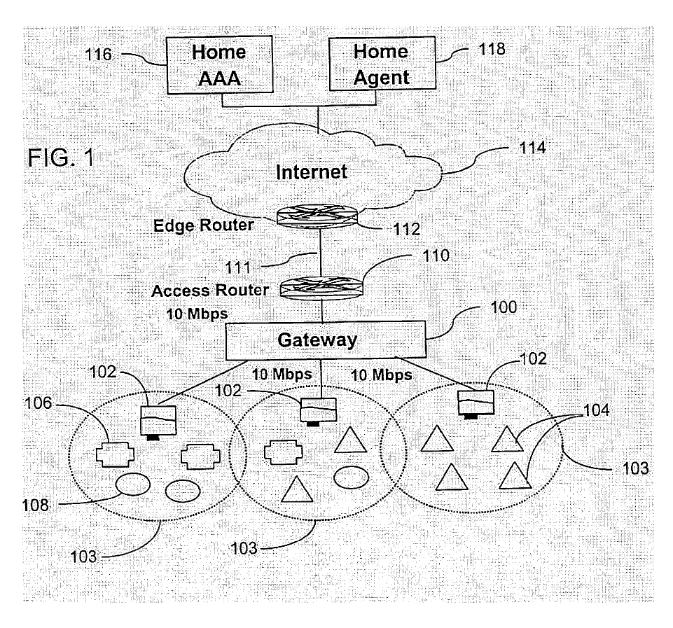

According to one embodiment of the invention shown in FIG. 1, a gateway 100 (hereinafter referred to as a “QoS gateway”), which implements Layer-3 IP-QoS mechanisms, is positioned between the 802.11 cell cluster 103 and the access router 110 of the wireless access network. Alternatively, the QoS gateway and the access router can be consolidated together in one physical component (e.g., box, not shown). The amount of the traffic competing for air link resources 102 is controlled to avoid congestion, instead of prioritizing traffic when congestion occurs. Thus, congestion at the 802.11 air link 102 can be effectively eliminated, because excessive traffic is queued and shaped by the QoS gateway 100. In other words, the total amount of traffic that enters an 802.11 cell 103 is always below the capacity of the 802.11 cell. The traffic prioritization and/or throttling is preferably performed at the QoS gateway 100 not at the air link 102.

For example, the following features are incorporated into one preferred embodiment of the present invention.

The QoS gateway 100 keeps track of the user population 104, 106, 108 and location via simple network management protocol (SNMP) queries to the 802.11 Access Points 102 in the network. The up-to-date user population map is used to determine each user's throughput by a resource assignment algorithm.

The QoS gateway 100 runs the resource assignment algorithm to determine each user's uplink/downlink throughput based on the user map information and the user profile information. The user profile information is obtained from the user's home AAA server 116. Because both uplink and downlink traffic compete for the same frequency bandwidth in the 802.1 1 air link 102, this algorithm computes the resource assignment for both directions at once.

The QoS gateway 100 limits the throughput (or delay) of each user 104, 106, 108 by shaping and policing the traffic flow of each user (by queuing or dropping packets if necessary). Particularly, some exemplary embodiments take advantage of the TCP flow control mechanism that reduces the window size when the ACK message timeout occurs. This is optional, however, and other embodiments do not rely on TCP.

In one preferred embodiment, traffic is controlled at the Layer-3 (network layer), instead of at Layer-2 (link layer). Virtually all of the existing QoS schemes for 802.11 networks (including the proposal by the IEEE 802.11e working group) operate at the Medium Access Control (MAC) layer, which is Layer-2, typically by manipulating the back-off mechanism. The exemplary techniques are essentially transparent to the 802.11 equipment 102.

The 802.11 air-link QoS complements the exemplary flow control method to achieve more accurate and efficient QoS provision (because embodiments of the present invention do not need to rely on the TCP flow control behavior which can cause a waste of bandwidth in some cases). The techniques described herein are not 802.11-specific and are applicable to any kind of multi-access style wireless technologies, including but not limited to Hyper-LAN, Home-RF, and Blue-tooth.

FIG. 1 shows the overall architecture of one embodiment of the present invention. The connection between the QoS gateway 100 and the 802.11 Access Points (AP) 102 can be point-to-point links or shared media networks such as Ethernet. Alternatively, Layer 3 devices like routers or switches can also be used to connect the 802.11 AP cluster to the QoS gateway 100, assuming that those devices do not conduct their own QoS scheduling.

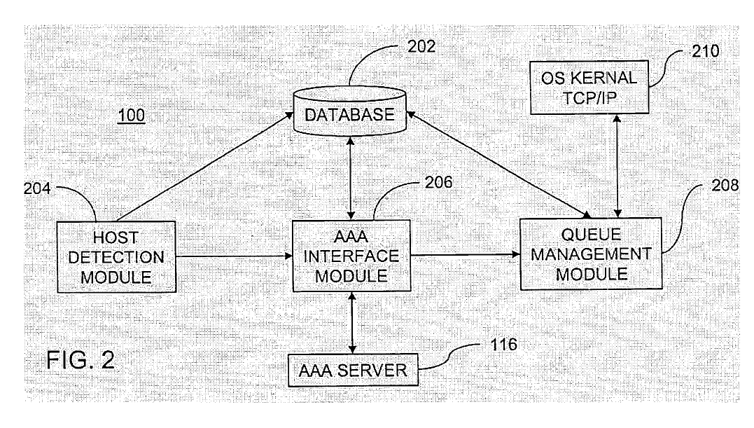

The QoS gateway 100 (shown in more detail in FIG. 2) manages bandwidth in two spots where congestion can occur, namely (1) the 802.11 cells 103, and (2) the ISP link 111.

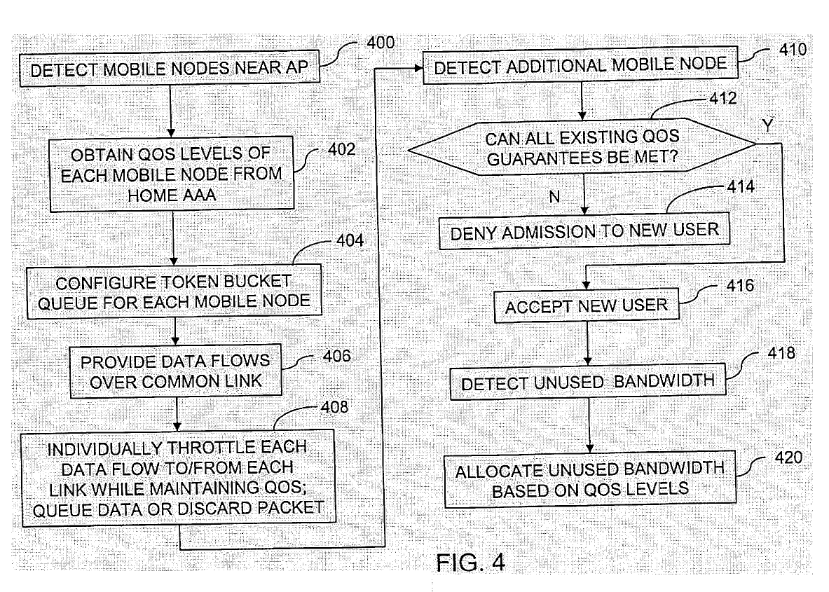

FIG. 4 is a flow diagram of a method for implementing the QoS levels. Further details of the individual steps are provided further below.

At step 400, the gateway 100 detects a plurality of mobile nodes within the range of an AP 102.

At step 402, the gateway 100 obtains the QoS levels for each mobile node from that mobile node's respective home AAA server 116.

At step 404, the gateway 100 configures a token bucket queue for each of the mobile nodes.

At step 406, the individual data flows for each mobile node are provided over the wireless link.

At step 408, each data flow is individually throttled while maintaining the desired QoS for the corresponding mobile node. For example, where TCP is used, the gateway may either queue packets for discard packets to reduce the data flow to a particular user.

At step 410, an additional mobile node is detected proximate to the AP 102.

At step 412, a determination is made whether the admission of the additional mobile node to the AP will interfere with meeting the QoS guarantees of the existing mobile nodes that are already using the AP.

At step 414, if admission would interfere with an existing QoS guarantee, access is denied.

At step 416, if all existing QoS guarantees can be met, then the new user is accepted.

At step 418, unused bandwidth is detected.

At step 420, any unused bandwidth is allocated based on the QoS levels of each user.

The operation of the QoS gateway 100 is preferably divided into three steps, and the QoS gateway comprises the following three main modules that perform the three steps:

Host detection module 204

AAA interface module 206

Queue management module 208.

First, the host detection module 204 identifies a host 106, 106 or 108 (treating each host as a unique user) in an 802.11 cell 103. Second, the AAA interface module 206 obtains the service class information for the user from the AAA server 116. Third, the queue management module 208 computes the amount of resources for the user and assigns a QoS queuing mechanism that provides the computed capacity for the user. FIG. 2 depicts the control flow among the three modules 204, 206, 208 and the interaction with other related components 202, 210, 116. A database 202 is preferably utilized to store the user information that is updated and accessed by the three modules 204, 206, 208.

### Host Detection Module 204

The QoS gateway 100 preferably uses SNMP queries to 802.11 APs 102 to detect the change of user population and location. Most 802.11 AP models support SNMP for configuration and monitoring purposes. Among the SNMP management information bases (MIBs) typically exported by 802.11 APs, the Bridge-MIB, which is defined in RFC 1493, is preferred. The QoS gateway 100 periodically fetches the bridge forwarding table from each AP 102 to locate currently active users 104, 106, 108. This method allows not only the detection of arrivals of new users and departures of existing users but also the detection of handover across 802.11 APs 102. In this way, the up-to-date user population map across the 802.11 cells is maintained. This map together with the user profile information from the AAA Interface Module 206 is used to determine each user's fair share of bandwidth, which is enforced by the Queue Management Module 208. The information from the bridge table is purely Layer-2 (i.e., MAC address), so the QoS-gateway 100 does not need a priori knowledge on the mobile hosts 104, 106, 108 such as their IP addresses. The host detection process is independent of any IP address-related procedures (e.g., Mobile-IP or DHCP), so this method is inter-operable with them and does not interfere with their operation.

### AAA Interface Module 206

The present invention does not require a particular AAA mechanism such as Radius. However, the AAA interface module 206 is preferably designed to interact with the AAA mechanism chosen. Typical AAA mechanisms used in 802.11 networks include the ‘open’ system, the ‘closed’ system which oftentimes is combined with Radius, and the IEEE 802.1X +Extended Authentication Protocol (EAP). Alternatively, a Mobile-IP authentication mechanism or MAC-address-based DHCP authentication mechanism may be used. When a new host is detected by the host detection module 204, the AAA interface module 206 takes over the control and sends a request for the user profile information to the AAA server 116—thus, the QoS gateway 100 works as a AAA client. The AAA server 116 preferably maintains the class attribute for each user.

### Queue Management Module 208

Some preferred embodiments provide a per-host QoS guarantee. To this end, in a preferred embodiment, a pair of Token Bucket Queues (TBQ) with a certain capacity is assigned for each host, one queue for upstream traffic, the other for downstream traffic. (Note that using token buckets is just one possible implementation option and is not essential to practice the invention.). The TBQ drops or delays the excessive incoming traffic in order to shape the resulting traffic to conform to the specified capacity. For instance, the upstream traffic for a user is shaped and policed by the queue at the QoS gateway 100, and as a result the amount of traffic pumped into an ISP uplink 111 is properly controlled. The amount of data pumped into the 802.11 air link by that upstream traffic is controlled indirectly by the flow control in the user's TCP. That is, since the upstream TBQ limits the outgoing packet delivery rate, the user's TCP slows down the packet generation rate to adapt to the current pipe size available. When a sudden reduction of queue capacity is necessary, the QoS gateway 100 may send an ICMP Source-Quench message to the corresponding host to accelerate the TCP window size reset by not waiting for the expiration of TCP-ACK message. Similar traffic shaping is preferably conducted in the downstream case.

TBQ is a simple QoS mechanism with very low performance overhead, and is available in many platforms including Linux, but is not the only QoS mechanism. Other priority queuing mechanisms like class based queuing (CBQ) or weighted fair queuing (WFQ) can be used instead of TBQ. The detail design and implementation of the queue management module 208 depends to some degrees on the queue mechanisms chosen and the platform adopted.

The capacity of each queue is preferably determined by the resource allocation algorithm based on three factors: (1) the user profile, (2) the load condition of network bottlenecks, and (3) the utilization levels of active queues. Depending on the pattern of user population and traffic activity, either/neither the 802.11 air-link or/nor the ISP link can become the bottleneck. Whenever a bottleneck occurs, the QoS gateway 100 tailors each user's traffic to prevent uncontrolled packet drop/delay at the bottleneck via traffic shaping for selected (or all) users. Furthermore, to achieve elastic resource management, the utilization of each queue is preferably periodically measured and the capacity of each queue is adjusted in the following way.

If a host 104, 106, 108 consumes only a small fraction of bandwidth as compared to the QoS level specified by the user profile, the remaining bandwidth allocated to the host is made to be available to other hosts until that host demands more bandwidth. Conversely, a host 104, 106, 108 can enjoy even higher throughput than the value specified in the user profile, if there is unused bandwidth by other users.

A straightforward extension of the above resource allocation algorithm is to provide admission control, which guarantees a minimum rate (i.e., throughput) or maximum delay to certain users. Guarantees cannot be made to a new user in the event the wireless link bandwidth (of the 802.11 cell that the user currently belongs to) or the ISP link bandwidth is already allocated to existing users for QoS guarantee. In such a case, the admission control can reject the user by blocking all traffic corresponding to that user, or can degrade the user to the best-effort class that does not get any guarantee. The elastic resource management allows the capacity reserved for under-utilized hosts to be used for other hosts. Therefore, having no guarantee does not mean that the host will always get a zero throughput. The guaranteed QoS level means that a host is guaranteed to be able to send (or receive) data at a certain throughput regardless of the current load condition.

In the case where one (or more) additional host(s) is (are) admitted without a QoS guarantee, some embodiments allow all excess bandwidth (beyond that already guaranteed to existing hosts) to be allocated to the additional host(s) on a best-effort basis. If more than one additional hosts are admitted without the QoS guarantee, they can share the excess bandwidth equally.

In other embodiments, the excess bandwidth is divided among the existing (guaranteed QoS) users and the additional (no guaranteed QoS) users. For this purpose, a “target” bandwidth may be assigned to the non-guaranteed users, for allocating the excess bandwidth among the guaranteed and non-guaranteed users in proportion to the service guarantees of the guaranteed users and the target bandwidth of the non-guaranteed users.

In some embodiments, the QoS guarantee is made on a per-user basis or a permobile-node basis. In other embodiments, the QoS gateway 100 may provide individual QoS guarantees for individual applications for each user. For example, within the user's guaranteed average throughput, there may be a QoS guarantee of a minimum bandwidth allocated to Internet downloads, or a minimum bandwidth allocated to electronic mail.

In some embodiments, the QoS levels do not correspond to guaranteed throughput levels, but maximum throughput levels. For example, a gold class user may be allocated a maximum throughput of 1.5 Mbps, a silver class user a maximum of 1.0 Mbps, and a bronze class user a maximum of 0.5 Mbps. When the sum of all the users maximum throughputs exceeds the bandwidth of the link, each user's throughput is reduced in proportion to its maximum. For example, if the sum of the users' maximum throughputs is 9 Mbps, and the link bandwidth is 4.5 Mbps, every user may be allocated one half his or her maximum. The gold class user would receive 0.75 Mbps, the silver class user would receive 0.5 Mbps, and the bronze class user would receive 0.25 Mbps.

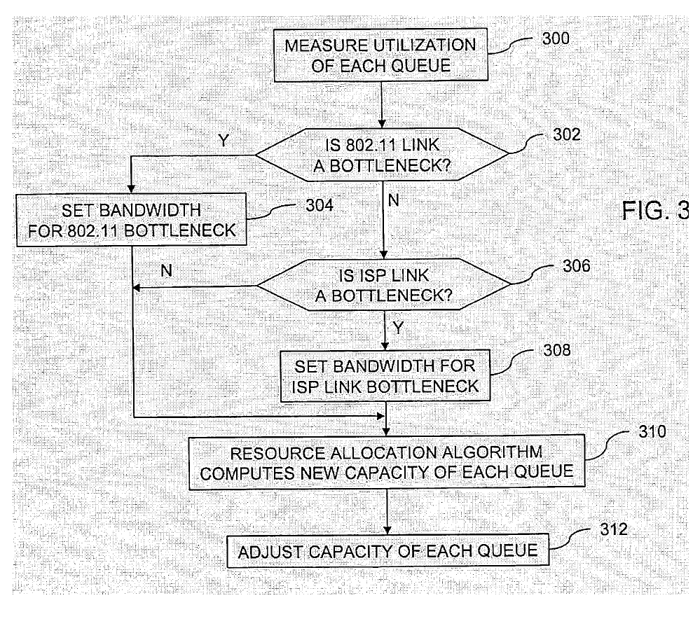

FIG. 3 shows the flow diagram of the queue management module. The prioritized assignment of the excess resources to non-satisfied users is the key function of the resource allocation algorithm. However, notice that this is just one example of many possible resource allocation algorithms.

At step 300, the utilization of each queue is measured.

At step 302, a determination is made whether the wireless (e.g., 802.11) link 102 is a bottleneck. This could occur if too many mobile nodes are simultaneously admitted to transmit or receive data by way of an individual access point 102.

At step 304, if the wireless link 102 is a bottleneck, then the amount of bandwidth that is to be divided among the registered wireless link users is set to the appropriate value for a wireless link bottleneck.

At step 306, a determination is made whether the ISP link 111 is a bottleneck. This could occur if the aggregate of all the data flows through all of the access points is too large for the bandwidth of the ISP link.

At step 308, if the ISP link is the bottleneck, then the bandwidth to be divided up is set to the appropriate value for an ISP link bottleneck.

At step 310, the resource allocation algorithm computes the new capacity of each queue. As noted above, where there are guaranteed QoS levels, each guaranteed QoS user is allocated at least the guaranteed average bandwidth (or at most the guaranteed average packet delay). Any excess bandwidth may either be divided proportionately among guaranteed QoS users, or additional users may be admitted. Additional users can only receive a QoS guarantee if the total of such guarantees does not exceed the total bandwidth (of the access point for an 802.11 bottleneck, or the total bandwidth of the ISP link for an ISP bottleneck). In other embodiments, where a maximum bandwidth (but not guaranteed bandwidth) is defined for each user, each user receives a bandwidth given by:

$$\begin{matrix} & & & & & & \begin{matrix}B ( i ) = MB ( i ) * \frac{LB}{SB} , & if LB < SB \\ = MB ( i ) , & if LB \geq SB\end{matrix} \\ where & & & & & & \\ & & & & & & SB = {\sum }_{i = 1}^{N} MB ( i ) ,\end{matrix}$$

B(i) is the bandwidth to be allocated to user (i), MB(i) is the maximum bandwidth allocable to user (i), LB is the link bandwidth, and N is the number of users.

At step 312, the capacity of each queue is adjusted.

### Performance of QoS Mechanism

The performance characteristics of the QoS gateway rate adaptation mechanism which enables QoS guarantees was demonstrated. In the following three scenarios, three MS-Windows laptops were wirelessly connected to a single 802.11 AP. On each laptop, an FTP application was run to download a large file from an external server. The back-haul connection of the QoS gateway was configured to be a 10 Mbps Ethernet.

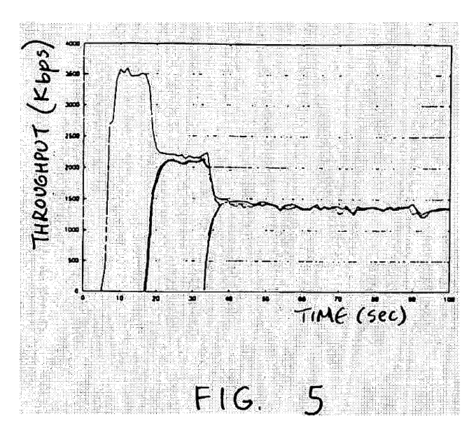

FIG. 5 shows a first example in which three users attempt to use a link, beginning at different times. This scenario (FIG. 5) illustrates restricting per-user traffic to 3.5 Mbps. At first, a single user gets 3.5 Mbps. As a second and a third user arrives, they all get equal share of the available bandwidth which is around 4.5 Mbps (which is lower than the capacity of an 802.11b cell; this is due to contention among users and uplink control traffic). In this example, each user has the same QoS level. Initially, user 1 has exclusive use of an access point, and is limited to about 3.5 Mbps bandwidth. This is less than the total bandwidth available on the link. At about 18 seconds elapsed time, user 2 begins to access the link. Within a very short period, the bandwidth for user 2 reaches about 2.2 Mbps, and that of user 1 drops to about the same. Thus, the two users are sharing the total bandwidth of the link—about 4.4 Mbps. At about 33 seconds elapsed time, user three begins to access the link. All three users are very quickly allocated about 1.4 to 1.5 Mbps.

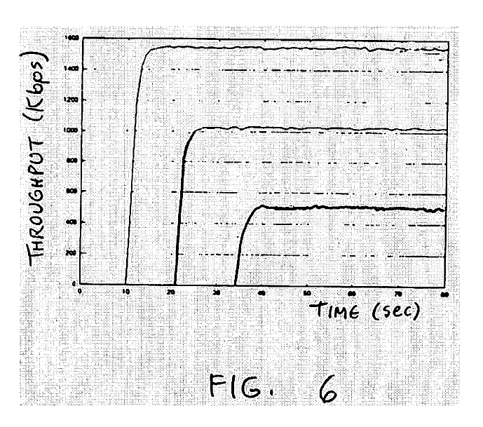

FIG. 6 shows an example in which three users have respectively different QoS levels. In this scenario, the class-based configuration was enabled with Gold, Silver and Bronze classes with maximum rates of 1.5 Mbps, 1 Mbps, and 0.5 Mbps, respectively. In this case, the total of the maximum bandwidths allocable to the three users is less than the total bandwidth (about 4.5 Mbps) available on the link. Initially, the Gold class user has throughput of about 1.5 Mbps. At about 20 seconds elapsed time, the Silver class user begins using about 1 Mbps. The Gold class user's data rate is unaffected. At about 34 seconds elapsed time, the Bronze class user is allocated about 0.5 Mbps bandwidth. Both the Gold and Silver class users are substantially unaffected. FIG. 6 shows that the QoS level of each class is maintained quite well. The slightly higher actual throughput than the specified maximum rate is attributed to the selection of token bucket parameters.

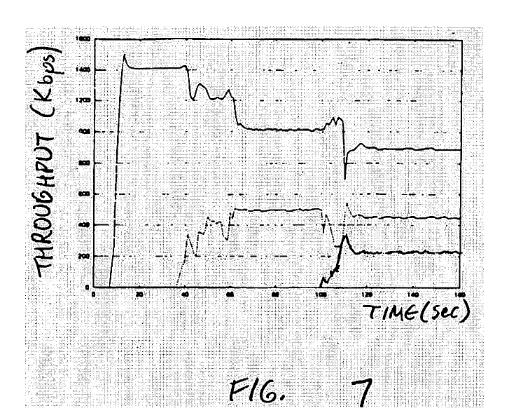

FIG. 7 shows a third scenario in which class-based queuing works with a background load of 3 Mbps (essentially reducing the available bandwidth of the link to 1.5 Mbps). A single Gold user (max rate 1.5 Mbps) is able to access all of the 1.5 Mbps initially. However, beginning at about 40 elapsed seconds, as Silver (max rate 1 Mbps) user begins to use the link, the Gold user's bandwidth drops to about 1 Mbps, while the Silver user receives about 0.5 Mbps. At about 100 seconds elapsed time, the Bronze (500 Kbps) user arrives, and the available bandwidth is shared proportionately to their maximum rate. The Gold user's rate again drops to about 0.9 Mbps, the Silver user to about 0.4 Mbps, and the Bronze user only receives about 0.2 Mbps. The jittery periods are due to the rate adjustments and their length depends primarily on the QoS rate adaptation algorithm.

Some embodiments also preferably support Mobile-IP tunnels and IP-sec tunnels. The queue management module is preferably aware of the mapping between the tunnel IP addresses and the encapsulated packet's IP addresses. A Mobile-IP Foreign Agent (which can reside inside the QoS gateway) preferably informs the QoS gateway of the address of Mobile-EP user's Home Agents. The EP-sec tunnel that is initiated by a user host contains the host IP address at the tunnel header, so that the QoS gateway can identify the sessions.

The present invention may be implemented with any combination of hardware and software. The present invention may be embodied in the form of computer-implemented processes and apparatus for practicing those processes. The present invention can be included in an article of manufacture (e.g., one or more computer program products, having, for instance, computer usable media). The present invention may also be embodied in the form of computer program code embodied in tangible media, such as floppy diskettes, read only memories (ROMs), CD-ROMs, hard drives, ZIP™ disks, flash memory, memory sticks, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claim should be construed broadly, to include other variants and embodiments of the invention which may be made by those skilled in the art without departing from the scope and range of equivalents of the invention.

We claim:

1. A method for handling flow of data to or from a plurality of mobile nodes, comprising the steps of:
providing a plurality of data flows to or from a plurality of respective mobile nodes over a common link with at least two quality of service levels;
individually throttling respective data flows to or from each mobile node while maintaining each data flow greater than or equal to its respective quality of service level.

2. The method of claim 1, wherein the throttling step includes using a token bucket queue to limit a data flow to at least one of the mobile nodes.

3. The method of claim 2, wherein the throttling step includes using a second token bucket queue to limit a data flow from the at least one of the mobile nodes.

4. The method of claim 1, wherein the throttling step includes queuing data in a gateway.

5. The method of claim 1, wherein at least one of the data flows comprises packets transmitted using a guaranteed delivery protocol, and the throttling step includes discarding a subset of the packets.

6. The method of claim 1, wherein the quality of service levels correspond to one of the group consisting of a guaranteed minimum average throughput and a guaranteed maximum average packet delay.

7. The method of claim 1, wherein each of the plurality of data flows has a guaranteed bandwidth, and the plurality of data flows are subject to a maximum collective total link bandwidth, the method further comprising:
detecting an additional mobile node;
denying a guaranteed bandwidth to the additional mobile node if a sum of the guaranteed bandwidths of the plurality of data flows and the guaranteed bandwidth of the additional mobile node would exceed the maximum collective total link bandwidth.

8. The method of claim 7, further comprising allocating unused capacity reserved for one of the plurality of mobile nodes to the additional mobile node.

9. The method of claim 7, further comprising denying admission to the additional node if a sum of the guaranteed bandwidths of the plurality of data flows and the guaranteed bandwidth of the additional mobile node would exceed the maximum collective total link bandwidth.

10. The method of claim 1, further comprising:
monitoring which mobile nodes are proximate to an access point;
identifying a condition in which available bandwidth between the access point and the proximate mobile nodes is greater than a sum of a respective guaranteed bandwidth allocated to each of the proximate mobile nodes; and
allocating any excess bandwidth to each of the proximate mobile nodes in proportion to the respective guaranteed bandwidth allocated to each of the proximate mobile nodes.

11. The method of claim 1, wherein the throttling step includes preventing excess traffic from reaching a wireless link used to transmit the data flows to the mobile nodes.

12. The method of claim 1, wherein the throttling step includes preventing excess traffic from reaching an 802.11 access point used to transmit the data flows to the mobile nodes.

13. The method of claim 1, further comprising obtaining an identification of the quality of service level of each respective mobile node from a respective home authentication, authorization and accounting agent of that mobile node.

14. A method for handling flow of data to or from a plurality of mobile nodes, comprising the steps of:
providing a plurality of data flows to or from a plurality of respective mobile nodes over a common link with at least two quality of service levels;
individually throttling respective data flows to or from each mobile node, so that the respective data flow to or from each mobile node does not exceed a maximum rate associated with the quality of service level of that mobile node, and the rates of each respective throttled data flow are reduced by a respective amount that depends on the individual mobile node.

15. The method of claim 14, wherein the rates of each respective throttled data flow are reduced by a respective amount that depends on the respective maximum rates assigned to the quality of service level of the corresponding mobile node.

16. A gateway for handling flow of data to or from a plurality of mobile nodes, comprising:
an authentication, authorization and accounting interface that receives information defining respective quality of service (QoS) levels for a plurality of mobile nodes, wherein the QoS levels are selected from a group of at least two QoS levels; and
a queue manager that individually throttles respective data flows to or from each mobile node while maintaining each data flow greater than or equal to its respective QoS level.

17. The gateway of claim 16, wherein the queue manager includes a token bucket queue to limit a data flow to at least one of the mobile nodes.

18. The gateway of claim 17, wherein the queue manager includes a second token bucket queue to limit a data flow from the at least one of the mobile nodes.

19. The gateway of claim 16, wherein the queue manager queues data in the gateway.

20. The gateway of claim 16, wherein at least one of the data flows comprises packets transmitted using a guaranteed delivery protocol, and the queue manager causes the gateway to discard a subset of the packets.

21. The gateway of claim 16, wherein the quality of service levels correspond to one of the group consisting of a guaranteed minimum average throughput and a guaranteed maximum average packet delay.

22. The gateway of claim 16, wherein each of the plurality of data flows has a guaranteed bandwidth, and the plurality of data flows are subject to a maximum collective total link bandwidth, the gateway further comprising:
a host detection module for detecting an additional mobile node,
wherein the queue manager denies a guaranteed bandwidth to the additional mobile node if a sum of the guaranteed bandwidths of the plurality of data flows and the guaranteed bandwidth of the additional mobile node would exceed the maximum collective total link bandwidth.

23. The gateway of claim 22, wherein the queue manager allocates unused capacity reserved for one of the plurality of mobile nodes to the additional mobile node.

24. The gateway of claim 223 wherein the queue manager denies admission to the additional node if a sum of the guaranteed bandwidths of the plurality of data flows and the guaranteed bandwidth of the additional mobile node would exceed the maximum collective total link bandwidth.

25. The gateway of claim 16, further comprising:
a host detection module for monitoring which mobile nodes are proximate to an access point connected to the gateway,
wherein the queue manager identifies a condition in which available bandwidth between the access point and the proximate mobile nodes is greater than a sum of a respective guaranteed bandwidth allocated to each of the proximate mobile nodes, and
the queue manager allocates any excess bandwidth to each of the proximate mobile nodes in proportion to the respective guaranteed bandwidth allocated to each of the proximate mobile nodes.

26. The gateway of claim 16, wherein the queue manager prevents excess traffic from reaching a wireless link used to transmit the data flows to the mobile nodes.

27. The gateway of claim 16, authentication, authorization and accounting interface receives the information corresponding to each respective mobile node from a respective home authentication, authorization and accounting agent of that mobile node.

28. A computer readable medium encoded with computer program code, wherein, when the code is executed by a processor, the processor performs a method for handling flow of data to or from a plurality of mobile nodes, comprising the steps of:
providing a plurality of data flows to or from a plurality of respective mobile nodes over a common link with at least two quality of service levels;
individually throttling respective data flows to or from each mobile node while maintaining each data flow greater than or equal to its respective quality of service level.

29. A computer readable medium encoded with computer program code, wherein, when the code is executed by a processor, the processor performs a method for handling flow of data to or from a plurality of mobile nodes, comprising the steps of:
providing a plurality of data flows to or from a plurality of respective mobile nodes over a common link with at least two quality of service levels;
individually throttling respective data flows to or from each mobile node, so that the respective data flow to or from each mobile node does not exceed a maximum rate associated with the quality of service level of that mobile node, and the rates of each respective throttled data flow are reduced by a respective amount that depends on the individual mobile node.
